(19) United States
(12) Patent Application Publication
(10) Pub. No.: US 2014/0138889 A1
(43) Pub. Date: May 22, 2014

(54) PROGRESSIVE-ACTING SUSPENSION DEVICE / DAMPER FOR VEHICLES

(71) Applicants: Giuseppe Bellandi, Roncadelle (BS) (IT); Graziano Mafezzoni, Roncadelle (BS) (IT)

(72) Inventors: Giuseppe Bellandi, Roncadelle (BS) (IT); Graziano Mafezzoni, Roncadelle (BS) (IT)

(21) Appl. No.: 14/119,164

(22) PCT Filed: May 21, 2012
(86) PCT No.: PCT/IB2012/052535

§ 371 Date: Nov. 20, 2013

(30) Foreign Application Priority Data
May 23, 2011 (IT) BS2011A000074

(51) Int. Cl. F16F 9/096; B60G 15/06; B60G 15/12; F16F 13/20

(52) U.S. Cl. CPC F16F 9/096; F16F 13/20; B60G 15/06; B60G 15/12
USPC 267/219

(57) ABSTRACT

A suspension device/damper for vehicles is provided, which includes a hydraulic damping unit (11) substantially acting linearly having a piston (20) provided with a guide rod (21) and operating in a chamber (16) containing an incompressible fluid. With the hydraulic damping unit (11) is combined a pneumatic damping unit (12) having progressive effect, activated by and collaborating with the damping action of said hydraulic unit. The pneumatic damping unit (12) includes a pressing head (23) operating through an elastic membrane (24) onto an air cushion (25) with a variable effect in response to the movements of the piston (20) in the chamber containing the incompressible fluid of the hydraulic damping unit (11).

### FIELD OF THE INVENTION

The present invention relates in general to both four- and two-wheel vehicles, and specifically relates to a suspension device/damper for such vehicles.

### STATE OF THE ART

The wheels of vehicles, specifically motorbikes and similarly bikes, can be supported by means of damper suspensions intended to absorb impacts and reduce abrupt load increases on wheels due both to the unevenness of the ground the vehicle is running and the landing after a possible jump as it can occur, for example, with trail motorbikes and/or similarly with trail bikes.

A suspension device/damper can be of spring type as disclosed, for example, by the documents U.S. Pat. No. 4,360,214 and EP 1 223 101 or hydraulic type as disclosed, for example, by the document EP 1 535 828 or hydro pneumatic, each one with features, performances and also drawbacks well known to the field technicians.

Then specifically, in the two wheels vehicles, for example, the suspension is generally located almost vertically, linked, downside, to an oscillating fork and, upside, to an upper part of the frame. The action of a suspension of known type for the use on two wheels vehicles can also be adjusted by acting on the relative spring or springs or on the hydraulic system to modify the preload thereof, but its effect still remains linear unless recurring to an additional linkage to render the action progressive and more effective.

However, the adoption of an additional leverage is prone to disadvantageously increase complexity, volumes and weight of the suspension, as well as the geometry of the vehicle.

### OBJECT AND SUMMARY OF THE INVENTION

The present invention has been designed to overcome at least the drawbacks of the known technique and with the aims of simplifying the structure of a suspension device for vehicles, avoiding mechanical springs, as well as reducing volumes and weight of the device all performances being equal.

A further object of the invention is to propose, specifically, a new and original suspension device having progressive effect without having to recur to bulky linkages, meaning to increase its reaction and stiffness as of the load it is subjected to increases from time to time, usable according to different arrangements within the scope of a vehicle and designed to advantageously reduce the spaces it occupies so to allow new and more suitable geometries in the manufacturing of vehicles, particularly the two wheel vehicles.

This object is reached, in accordance with the invention, by a suspension device/damper for vehicles according to claim 1, the device comprising, thus, a hydraulic damping unit substantially acting linearly in combination with an essentially pneumatic unit having progressive damping action able to aid the damping action of the hydraulic damping unit.

Specifically the hydraulic damping unit includes a piston provided with a guide rod and acting in a chamber containing an incompressible fluid, such as damping oil. From its part the pneumatic damping unit comprises a pressing head operating through an elastic membrane onto an air cushion with a variable, progressive effect in response to the movements of the piston in the chamber containing incompressible fluid of the hydraulic damping unit.

Advantageously, at least one from the elastic membrane and the pressing head, or preferably both, have curved, preferably convex, front contacting surfaces, one's contrary to each other's. What above so that the contacting surface between the two components progressively increases with a forward motion of the pressing head towards the membrane, or vice versa of the membrane towards the pressing head.

Advantageously the pressing head is combined with the piston rod of the hydraulic damping unit therefore it will move with respect to the membrane depending on the movements of said piston and, thus, on the stresses the suspension is subjected to.

Preferably the two units are coaxially integrated in a same body with a member in common able to activate both the hydraulic unit and the pneumatic damping unit in response to the load the suspension is subjected to. The common member is the piston rod that follows, on the one hand, the piston movements and carries the pressing head operating onto the air cushion having progressive damping effect on the other hand.

Substantially, as a whole the pneumatic damping unit allows to give the suspension device a progressive effect of oscillation smoothing of a member of a vehicle to be damped in response to the ground conditions it has to travel through, and this without recurring to bulky leverages and with the advantage of increasing reaction and stiffness of the suspension as the load it is subjected to increases from time to time.

### BRIEF DESCRIPTION OF THE DRAWINGS

Further details of the invention will be evident from the following description course made with reference, by way of example only and without limitation, to the attached drawings, in which:

FIG. 1 shows a schematic view of the suspension device/damper in a first inactive position;

FIG. 2 shows the device of FIG. 1 in an active position; and

FIGS. 3 and 4 show an example of application of the suspension device/damper to the fork of the rear wheel of a two wheels vehicle, in an inactive and active position respectively.

### DETAILED DESCRIPTION OF THE INVENTION

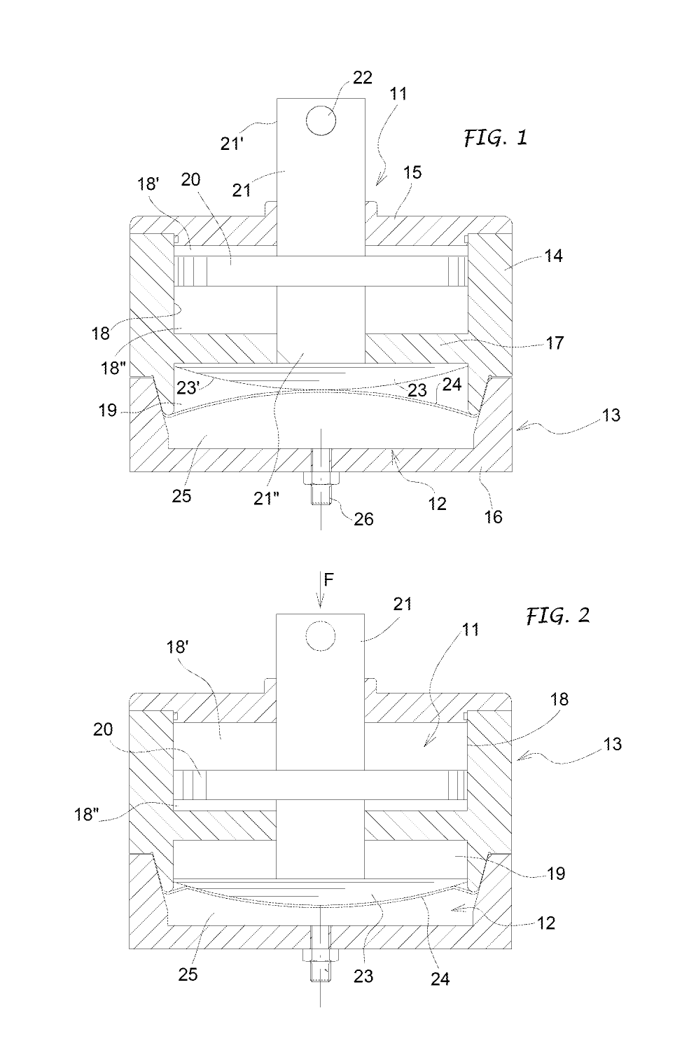

The device according to the invention essentially comprises a hydraulic damping unit 11 and a pneumatic damping unit 12. In the exemplary embodiment shown in FIGS. 1 and 2, the two hydraulic and pneumatic units 11, 12 are integrated in a same body 13, preferably coaxially.

Then such a body 13 can comprise a preferably cylindrical liner 14, whose opposite ends are closed by head 15 and bottom 16 flanges, respectively. Said liner and said flanges are coupled with the interposition of sealing gaskets. Further, inside said liner 14 an intermediate partition 17 parallel to the head and bottom flanges 15, 16 and defining with them a first chamber 18 and a second chamber 19 is provided.

In the illustrated example, the first chamber is provided to be part of the hydraulic damping unit 11, whereas the second chamber 19 is part of the pneumatic damping unit 12.

In the first chamber 18 a piston 20 is accommodated and movable and it is carried by a rod 21 which is guided and axially going through both the head flange 15 and the intermediate partition 17 of said body, with the interposition of suitable sealing gaskets—not represented.

Specifically, the rod 21 of the piston 20 has a first end 21′ axially extending outside of the head flange 15 and a second end 21″ facing towards and emerging into the second chamber 19.

The first end 21′ of the rod 21 may be connected, for example by a pin 22, either directly, or indirectly by means of at least one lever or other joint element, to a member to be damped, such as the support of a vehicle wheel, such that the piston 20 has to axially move in the first chamber 18 in response to the movements of such a member to be damped, which generally depend on the stresses the member is subjected to during the vehicle travel.

The first chamber 18 contains a hydraulic fluid, such as damper oil, and the piston 20 separates this first chamber in two compartments 18′, 18″, which have variable width according to its axial motions. The two compartments communicate hydraulically one to each other by at least one control passage for the fluid transit from one compartment to another according to the piston position, said at least one passage being obtained in the piston or in a portion of the body 13.

With the second end 21″ of the rod 21 of the piston 20 facing towards the second chamber 19 in the body 13 a solid pressing head 23 is combined, and in front of the pressing head 23 an elastic membrane 24 is placed whose periphery is conveniently secured in said second chamber.

The pressing head 23 can be integral with the rod 21 or linked thereto by means of a simple mechanical coupling.

The elastic membrane 24 defines, with the bottom flange 16, a compartment 25 having variable volume, intended to contain a compressible fluid, such as a gas, or preferably air, substantially constituting an air cushion. The compressible fluid can be arranged and contained directly in the compartment 25 by loading it through a loading valve 26 and providing the body with suitable sealing means at least at the level of the elastic membrane and the gasket between the liner 14 and the bottom flange 24 of the body 13. Alternatively the compressible fluid can be arranged and contained in a case or air chamber then to be placed in the compartment 25.

Specifically, the elastic membrane 24 in the resting state has a dome shape with a convexity facing towards the pressing head 23. Such a pressing head 23 in its turn has a front surface 23′ intended to rest on, and cooperate with, the elastic membrane 24.

The front surface 23′ of the pressing head 23 can have various shapes, as long as suitable to engage on the elastic membrane 24 with a surface that progressively increases from a starting position in which the pressing head is simply resting on the top of the dome membrane.

However, the elastic membrane 32 and the front surface 23′ of the pressing head 23 will be preferably equal and opposite, that is to say similarly convex and both with bending radius, which can be constant for their whole extension or variable from their center area towards their periphery. Therefore in an initial or resting condition, the pressing head and the elastic membrane will be leaning one on another limitedly to the top of their convex surfaces, in which condition the compartment 25 hosting the incompressible fluid or air cushion has a maximum preset volume.

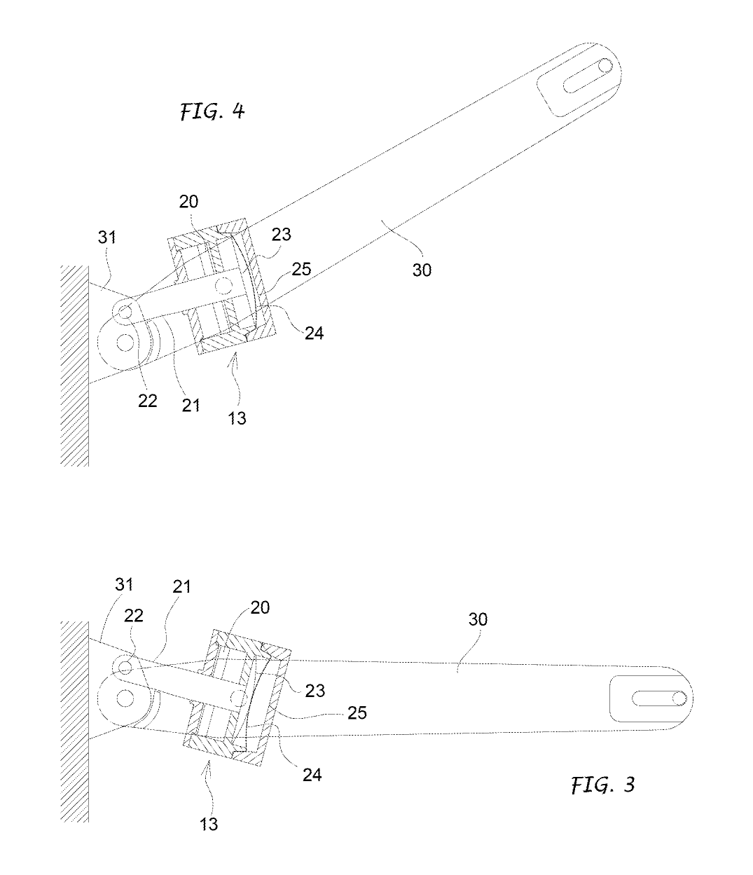

The suspension according to the invention can be applied to the wheels of vehicles according to different modes, one of which is represented, for example, in the FIGS. 3 and 4, with the suspension in an inactive and active condition, respectively. In this example application the body 13 of the suspension is secured to the fork 30 carrying the rear wheel of a two wheels vehicle, such as a motorcycle, whereas the rod 21 of the piston 20 of the hydraulic damping unit 11 is linked by the relative pin 22 to the frame of a vehicle.

In practice, and whatever the operating installation mode is, as long as the forces which are acting on the ,suspension, that is on the rod 21 of the piston 20, stay within preset limits, the device maintains an equilibrium condition, such as shown in the FIGS. 1 and 3, wherein the piston 20 and relative rod 21 are substantially static and the pressing head simply rests on the elastic membrane 24 substantially without deforming it, therefore without substantially affecting the volume of compressible fluid placed in the compartment 25 defined by the membrane itself.

Otherwise, when the suspension is stressed by outside forces F, as it can occur for example when the wheel of the vehicle runs a bumpy ground or as a consequence of a landing after a jump, a movements of the piston 20 occurs, in conjunction with the relative rod 21 in the first chamber 18 containing the hydraulic fluid, with the result of smoothing, that is to say of dumping the fork oscillations, therefore of the wheel. At the same time, the pressing head 23 connected to the rod 21 of the piston 20 and which follows its movements, engages on the elastic membrane 24 and, through the latter, on the compressible fluid placed in the compartment 25, constituting an air cushion.

Then and advantageously, the solid pressing head 23 substantially “sinks” into the elastic membrane 24 deforming it. Thus, because of the convex contacting surfaces, the more the pressing head 23 “sinks” into the membrane 24 the more the contacting surface (which can also be denoted with bore) increases, the more the volume of the compartment 25 hosting the compressible fluid decreases. The results is a progressive increase of the strength opposing to the motion of the rod 21 and, through this one, of the member to be damped, on the other hand, but not necessarily, strength also resulting from an increase of the pressure of the compressible fluid arranged in the compartment 25 or in the case or chamber located in said compartment and onto which the pressing head 23 acts through the elastic membrane 24.

Therefore at the level of the pneumatic damping unit 12 a progressive damping action is realized which adds to the substantially linear action of the piston in the first chamber 18 of the hydraulic damping unit 11 for a better response of the suspension to the stress it is subjected to from time to time.

Since the shape of the surfaces of the pressing head 23 and of the elastic membrane 24 contacting one to each other are preferably equivalent, the deformation of said membrane due to the pressing head will be uniform in all of its parts without folds or wrinkles which could affect its integrity.

1. A suspension device/damper for vehicles, comprising a body (13) provided with a hydraulic damping unit (11), comprising a first chamber (18) containing an incompressible fluid, and a pneumatic damping unit (12), comprising a second chamber (19) containing a compressible fluid, wherein the hydraulic damping unit (11) includes a piston (20) operating in the first chamber (18) and a corresponding guide rod (21), and the pneumatic damping unit (12) includes a pressing head (23) operating by means of an elastic membrane (24) on the compressible fluid of the second chamber (19) in response to the movements of the piston (20) in said first chamber,
the rod (21) of said piston (20) has a first end (21′) extending outside of said body (13) and a second end (21″) facing towards and emerging into said second chamber (19),
the first end of said rod (21) is connectable to a part of a system to be damped and the body (13) of the device to another part of the system to be damped,
the pressing head (23) of the pneumatic damping unit (12) is combined with the second end of said rod (21) emerging into said second chamber (19), and
at least one of the two elements selected from the pressing head (23) and the elastic membrane (24) has a curved front surface, preferably convex, contacting with the surface of the other element, so that the contacting surface between said two elements progressively increases with a forward motion of the pressing head with respect to the membrane, or vice versa of the membrane with respect to the pressing head, for a progressive, variable damping effect.

2. The suspension device/damper according to claim 1, wherein the pressing head (23) and the elastic membrane (24) both have a curved contacting surface, and wherein the curved surface of the elastic membrane and the pressing head are specular one to each other, so that the contacting surface between the pressing head and the elastic membrane progressively increases with a forward motion of the pressing head with respect to the membrane, or vice versa of the membrane with respect to the pressing head.

3. The suspension device/damper according to claim 2, wherein the curved contacting surfaces of the pressing head (23) and/or the elastic membrane (24) have equal or different bending radii.

4. The suspension device/damper according to claim 2, wherein the contacting surfaces of the pressing head (23) and/or the elastic membrane (24) have a constant or variable bending radius.

5. The suspension device/damper according to claim 1, wherein the pressing head (23) is integral or secured to the second end of said rod.

6. The suspension device/damper according to claim 1, wherein the hydraulic damping unit (11) and the pneumatic damping unit (12) have a member in common activating both the hydraulic damping unit and the pneumatic damping unit (12) in response to the load the device is subjected to, said member being the rod (21) of the piston (20) of the hydraulic damping unit.

7. The suspension device/damper according to claim 6, wherein the elastic membrane (24) defines in said second chamber (19) a compartment (25) containing the compressible fluid constituting an air cushion onto which the pressing head (23) progressively acts.

8. The suspension device/damper according to claim 7, wherein the compressible fluid is loaded in said compartment (25) directly between the elastic membrane (24) and a portion of the body (13) of the device.

9. The suspension device/damper according to claim 7, wherein the compressible fluid is contained in a case disposed and held in said compartment (25) in said second chamber (19).
